(19) United States
(12) Patent Application Publication
(10) Pub. No.: US 2018/0123386 A1
(43) Pub. Date: May 3, 2018

(54) APPARATUS FOR CONTROLLING POWER BASED ON UNINTERRUPTIBLE POWER SUPPLY SYSTEM

(71) Applicant: NEOTEK CO.,LTD., Busan (KR)

(72) Inventors: Hyun-Deuk CHOI, Busan (KR); Sang-Jin LEE, Busan (KR); Ki-Beak KAM, Busan (KR)

(21) Appl. No.: 15/340,413

(22) Filed: Nov. 1, 2016

(51) Int. Cl. H02J 9/06; H02J 13/00; H02J 7/00

(52) U.S. Cl. CPC H02J 9/06; H02J 7/0047; H02J 13/0062

(57) ABSTRACT

Disclosed is an apparatus for controlling power based on a UPS system, which is capable of effectively controlling the supply of alternative power from the UPS system. The apparatus for controlling power based on the UPS system includes a UPS module, itself including a battery, immediately supplying alternative power by switching to a shutdown state when power from an external power supply system is interrupted; a power distribution module, dividing a power system into power division sectors in advance and distributing the alternative power among the power division sectors; and a power control module, defining an emergency power supply level by measuring a state of charge of the battery, setting a priority order for the power division sectors in advance, and determining which of the power division sectors are supplied with the alternative power based on the emergency power supply level.

### BACKGROUND OF THE INVENTION

### Field of the Invention

The present invention relates generally to an apparatus for controlling power and, more particularly, to an apparatus for controlling power based on a UPS system, which is capable of effectively controlling the supply of alternative power from the UPS system.

### Description of the Related Art

Generally, an Uninterruptible Power Supply (UPS) system is a system in which some of the power supplied from a common power supply system is stored in a battery, and when an abnormal situation occurs in the common power supply system, power is supplied from the battery to an inverter, converted into alternating current (AC) power by the inverter and then supplied to a load. That is, in a normal state, a UPS system converts AC power into DC power and stores the DC power in a battery, but it converts the DC power, stored in the battery, into AC power using an inverter when a power failure, an interruption, a voltage fluctuation or the like occurs in the AC power supply. Such a UPS system is widely used in various fields in which very stable power supply is required, such as power plants, communications companies, broadcasting companies, hospitals and the like.

However, because the battery of a UPS system can only be charged with a fixed amount of power, there is a limited amount of time during which alternative power can be supplied using the UPS system.

There is also the problem where offshore plant facilities, new and renewable energy facilities, and the like, which operate their own power generation systems, are susceptible to losing important data, that are being handled during the operation of a power system, in the event of a sudden power failure due to the failure of the power system and then recovery of such lost data may be impossible. Important data may also not be properly detected and managed in a shutdown state resulting from power failure.

Also, a power system includes many complicated facilities, and any of these may fail for many different reasons. The causes of failure must be analyzed by an administrator, and such analysis is time-consuming, hindering immediate restoration to a normal state.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been developed keeping in mind the above problems, wherein an object of the present invention is to provide an apparatus for controlling power based on a UPS system, which maintains a state in which power is supplied without interruption for as long as possible in an emergency situation by effectively controlling the supply of alternative power based on the UPS system.

Another object of the present invention is to provide an apparatus for controlling power based on a UPS system, in which the detection and management of important data may be normally performed even in a shutdown state.

A further object of the present invention is to provide an apparatus for controlling power based on a UPS system, which immediately detects the sector in which a power failure occurs and interrupts the supply of power to the corresponding sector, such that quick restoration to a normal state may be possible.

The objects of the present invention are not limited to the above-mentioned objects, and other objects that have not been mentioned may be clearly understood from the following description by those skilled in the art to which the present invention pertains.

An apparatus for controlling power based on a UPS system according to the present invention includes an uninterruptible power supply (UPS) module, including a battery therein, immediately supplying alternative power by switching to a shutdown state when power from an external power supply system is interrupted; a power distribution module, dividing a power system into power division sectors in advance and distributing the alternative power among the power division sectors; and a power control module, defining an emergency power supply level by measuring a state of charge of the battery, setting a priority order for the power division sectors in advance, and determining which of the power division sectors are supplied with the alternative power based on the emergency power supply level.

The power distribution module of the present invention may also ascertain power data, which include at least one of RPM, generated power, consumed power, temperature and humidity, for each of the power division sectors not only in a normal state but also in a shutdown state, and may transmit the power data to the power control module.

Preferably, the apparatus for controlling power based on a UPS system according to the present invention may further include a data log module, connected with the power control module and storing the power data at a preset time interval.

Preferably, the apparatus for controlling power based on a UPS system according to the present invention may further include a data transmission module, connected with the power control module and transmitting the power data to an administrator's terminal using a cable or in a wireless manner.

The power control module of the present invention may isolate a power division sector in which a power failure occurs from the other power division sectors by receiving the power data, interrupting a supply of the alternative power to the isolated power division sector, and requesting release of the shutdown state.

The power control module of the present invention may isolate a power division sector in which a power failure occurs from the other power division sectors by receiving the power data, and if the isolated power division sector includes a power generator therein, the power control module may interrupt a supply of generated power to the external power supply system and then request release of the shutdown state.

The apparatus for controlling power based on a UPS system according to the present invention may effectively control the supply of alternative power from the UPS system, such that the state in which power may be supplied without interruption may be maintained for as long as possible in an emergency situation.

Additionally, the apparatus for controlling power based on a UPS system according to the present invention may ascertain and manage important data even in a shutdown state.

Additionally, the apparatus for controlling power based on a UPS system may detect the sector in which a power failure occurs and interrupt the supply of power to the corresponding sector, such that quick restoration to a normal state may be possible.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a block diagram illustrating an apparatus for controlling power based on a UPS system according to an embodiment of the present invention;

FIG. 2 is a flowchart describing the operation of an apparatus for controlling power based on a UPS system according to an embodiment of the present invention;

FIG. 3 is a circuit diagram showing a circuit that measures RPM in an apparatus for controlling power based on a UPS system according to an embodiment of the present invention; and

FIG. 4 shows two circuit diagrams each showing a circuit that measures the amount of power in an apparatus for controlling power based on a UPS system according to an embodiment of the present invention.

### DETAILED DESCRIPTION OF THE INVENTION

Specific features, including the objects of the present invention, the technical solutions for the objects, and the effects of the present invention, are included in the embodiment described below and in the accompanying drawings. The advantages and characteristics of the present invention and the method for achieving them may be clearly understood by referring to the accompanying drawings and the embodiment described below.

Hereinafter, the present invention will be described in detail with reference to the accompanying drawings.

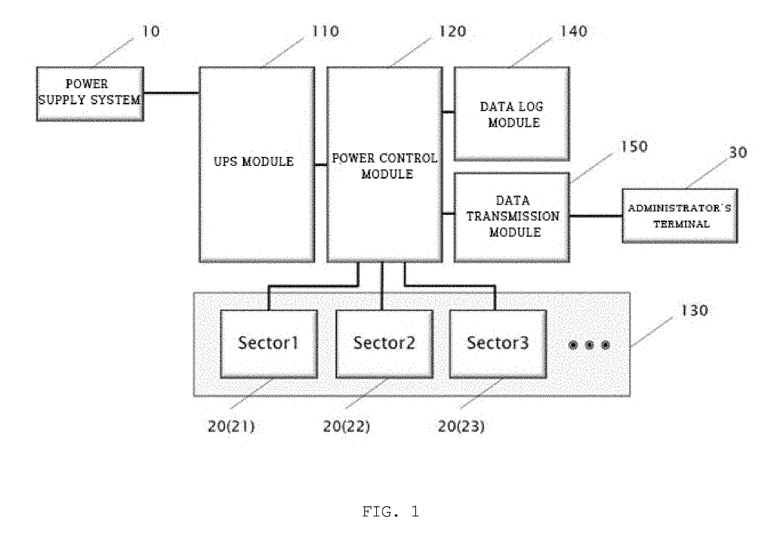

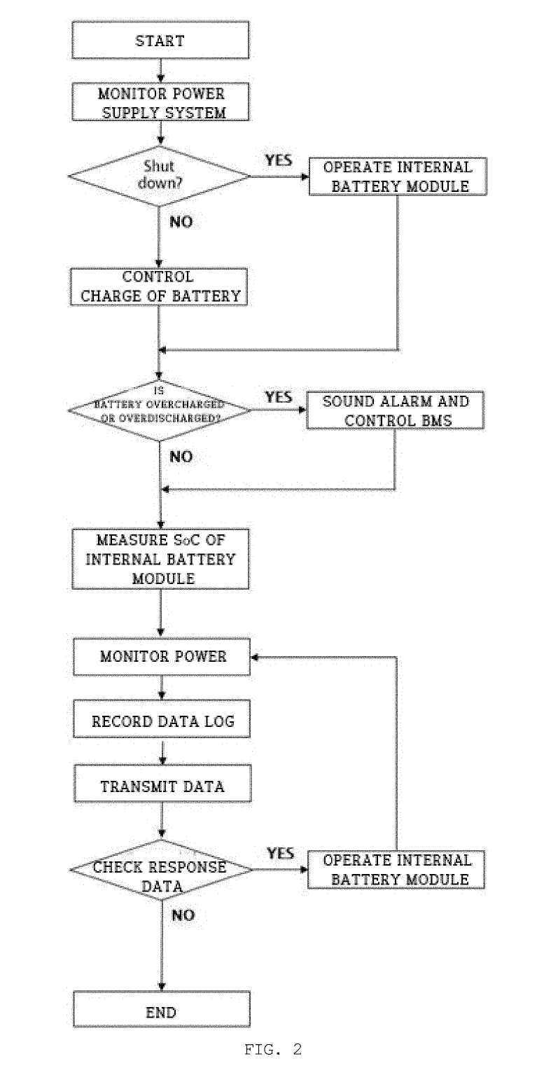

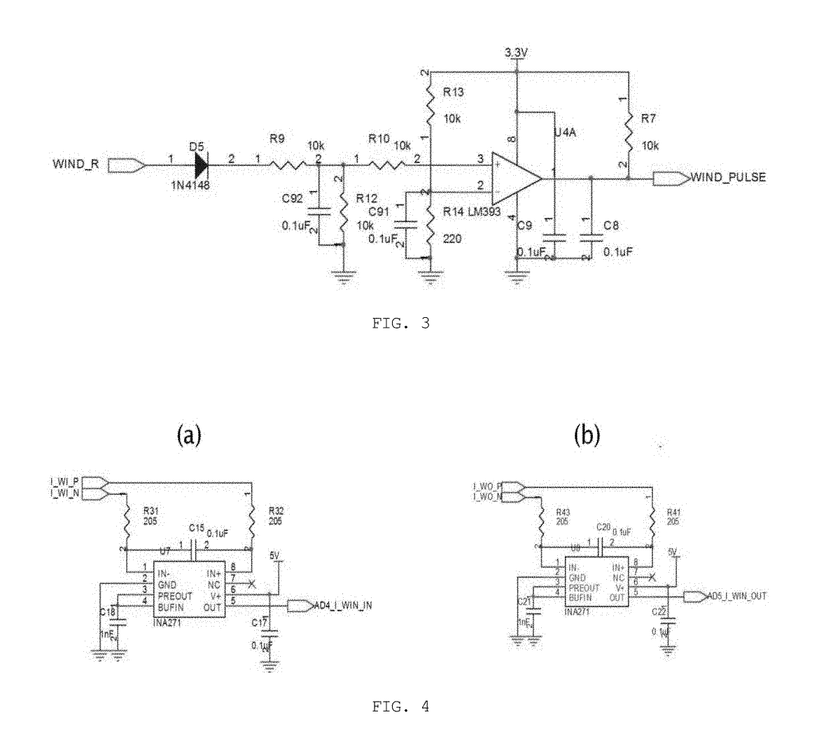

FIGS. 1 to 4 are diagrams describing an apparatus for controlling power based on a UPS system according to an embodiment of the present invention. Specifically, FIG. 1 is a block diagram illustrating an apparatus for controlling power based on a UPS system according to an embodiment of the present invention, FIG. 2 is a flowchart describing the operation of an apparatus for controlling power based on a UPS system according to an embodiment of the present invention, FIG. 3 is a circuit diagram showing a circuit that measures the RPM in an apparatus for controlling power based on a UPS system according to an embodiment of the present invention, and FIG. 4 shows two circuit diagrams each showing a circuit that measures the amount of power in an apparatus for controlling power based on a UPS system according to an embodiment of the present invention.

As illustrated in FIGS. 1 to 4, an apparatus for controlling power based on a UPS system according to an embodiment of the present invention includes a UPS module 110, a power distribution module 130 and a power control module 120.

The UPS module 110 includes a battery therein, that may immediately supply alternative power to the power control module 120 and the power distribution module 130 by switching to a shutdown state when the power from an external power supply system 10 is interrupted.

The power distribution module 130 divides the power system 20 into power division sectors 21, 22 and 23 in advance and distributes the alternative power among the power division sectors 21, 22 and 23.

The power control module 120 defines an emergency power supply level by measuring the state of charge (SOC) of the battery, sets the priority order for the power division sectors in advance, and controls the power distribution module 130 such that which of the power division sectors are supplied with the alternative power is determined based on the emergency power supply level.

In other words, when power is interrupted in the external power supply system 10, alterative power is supplied from the battery system within the UPS module 110 to the power control module 120, and the alternative power is distributed among the power division sectors 21, 22 and 23 through the power distribution module 130. The power control module 120 defines the emergency power supply level by measuring the state of charge (SOC) of the battery of the UPS module 110. Accordingly, the priority order of the power division sectors, defined by an administrator, is controlled based on the emergency power supply level, such that the state in which power can be supplied without interruption may be maintained for as long as possible.

As described above, because the apparatus for controlling power based on a UPS system according to an embodiment of the present invention may effectively control the supply of alternative power based on the UPS system, it is advantageous in that the state in which power can be supplied without interruption may be maintained for as long as possible.

Additionally, the power distribution module 130 may ascertain power data, which include one or more of RPM, generated power, consumed power, temperature and humidity, for each of the power division sectors and may transmit the ascertained power data to the power control module 120 in a shutdown state as well as in a normal state. Here, the generated power or the consumed power may be determined by measuring voltage and current.

The following refers to FIG. 3. In the case of a power generator generating power in the power system 20, then the power distribution module 130 includes an RPM measurement circuit, shown in FIG. 3, that converts one phase of the three-phase AC power into a DC signal, and transmits the DC signal to the power control module 120. The following refers to FIG. 4. In the case of the power generator generating power in the power system 20, then the power distribution module 130 includes a power measurement circuit, shown in FIG. 4, that measures the amount of generated power when connected to the input terminal and the output terminal of the power generator.

Additionally, the apparatus for controlling power based on a UPS system according to an embodiment of the present invention may further include a data log module 140, connected with the power control module 120 and storing power data at preset time intervals; and may further include a data transmission module 150, connected with the power control module 120 and transmitting the power data to an administrator's terminal 30 using a cable or in a wireless manner.

As described above, the apparatus for controlling power based on a UPS system according to the embodiment of the present invention may be widely used in various fields, such as in offshore plant facilities, new and renewable energy facilities, and the like, which operate their own power generation systems, and where important data may be detected, stored and transmitted even in a shutdown state.

Furthermore, the power control module 120 according to an embodiment of the present invention isolates the sector in which a power failure occurs from the other power division sectors by receiving the power data from the power distribution module 130, then through the power distribution module 103 interrupting the supply of the alternative power to the sector to be isolated and finally requesting the UPS module 110 to release the shutdown state.

Moreover, even in the shutdown state, the power distribution module 130 ascertains the power data generated in each sector, for example, power consumption determined by measuring voltage and current, temperature, humidity, signals indicative of various kinds of failure situations, or the like, and transmits the power data to the power control module 120, so that the sector in which the power failure occurs may be quickly isolated based on the transmitted data and appropriate further measures may be taken immediately.

If, in particular, the isolated power failure sector includes a power generator, the generated power is prevented from being supplied to the external power supply system 10, the cause of the failure is addressed, and then the release of the shutdown state is requested.

As described above, the apparatus for controlling power based on a UPS system according to an embodiment of the present invention is advantageous in that the sector in which a power failure occurs is immediately isolated and the supply of power to the corresponding sector is interrupted, so that quick restoration to a normal state is possible.

As described above, while the present invention has been described with reference to the exemplary embodiment, it will be understood by those skilled in the art that various changes, modifications and equivalent implementations may be made without changing the essential characteristics or technical spirit of the present invention.

Therefore, it is to be understood that the present invention is not limited to the forms described in the exemplary embodiment, rather that the technical and protective scope of the present invention is defined by the following claims. Additionally, it should also be understood that all modifications, changes and equivalent implementations permitted by the following claims belong to the technical scope of the present invention.

What is claimed is:

1. An apparatus for controlling power based on a UPS system, comprising:
an uninterruptible power supply (UPS) module, including a battery therein, immediately supplying alternative power by switching to a shutdown state when power from an external power supply system is interrupted;
a power distribution module, dividing a power system into power division sectors in advance and distributing the alternative power among the power division sectors; and
a power control module, defining an emergency power supply level by measuring a state of charge of the battery, setting a priority order for the power division sectors in advance, and determining which of the power division sectors are supplied with the alternative power based on the emergency power supply level.

2. The apparatus of claim 1, wherein the power distribution module ascertains power data, which include at least one of RPM, generated power, consumed power, temperature and humidity, for each of the power division sectors not only in a normal state but also in a shutdown state, and transmits the power data to the power control module.

3. The apparatus of claim 2, further comprising:
a data log module, connected with the power control module and storing the power data at a preset time interval.

4. The apparatus of claim 2, further comprising:
a data transmission module, connected with the power control module and transmitting the power data to an administrator's terminal using a cable or in a wireless manner.

5. The apparatus of claim 2, wherein the power control module isolates a power division sector in which power failure occurs from the other power division sectors by receiving the power data, interrupting a supply of the alternative power to the isolated power division sector, and requesting release of the shutdown state.

6. The apparatus of claim 2, wherein the power control module isolates a power division sector in which power failure occurs from the other power division sectors by receiving the power data, and if the isolated power division sector includes a power generator therein, the power control module interrupts a supply of generated power to the external power supply system and then requests release of the shutdown state.
